(19) United States
(12) Patent Application Publication
(10) Pub. No.: US 2005/0046830 A1
(43) Pub. Date: Mar. 3, 2005

(54) Polarized material inspection apparatus and system

(76) Inventors: John Karp, Freeport, ME (US); Dominic Pelletier, Raymond, ME (US)

Correspondence Address: Michael J. Persson;Lawson & Persson, P.C., Suite 103, 67 Water Street, Laconia, NH, 03246, US

(21) Appl. No.: 10/747,515

(22) Filed: Dec. 29, 2003

Related U.S. Application Data
(63) Continuation-in-part of application No. 09/543,650, filed on Apr. 5, 2000, now Pat. No. 6,697,156.
(60) Provisional application No. 60/129,645, filed on Apr. 16, 1999.

(51) Int. Cl. G01N 21/88

(52) U.S. Cl. 356/237.1; 356/364

(57) ABSTRACT

A polarized material inspection device that includes a light source, a first polarizing filter disposed within the optical path of the light source, a frame into which a second polarizing filter is disposed, and a support for positioning the frame such that an object may be viewed through the second polarizing filter. In the preferred embodiment, the first polarizing filter is rotatable through a ninety degree arc such that planes of polarization may be adjusted to be parallel or orthogonal to one another. The preferred embodiment also includes a light illumination assembly having a rotatably mounted linear polarizer at the polarizing output end. This light assembly is attached to a portion of the frame and may be adjusted such that the beam of light is directed to the desired portion of the surface. Within the frame is mounted a fixed linear polarizing filter of sufficient size to allow the entire illuminated surface to be viewed. The frame is mounted to an adjustable support arm that is attached to a tripod or other support to allow the apparatus to be fixed during a given procedure.

This application is a Continuation-in-Part of co-pending U.S. patent application Ser. No. 09/543,650, filed Apr. 5, 2000, which claims the benefit of U.S. Provisional Patent Application Ser. No. 60/129,645, filed Apr. 16, 1999.

### FIELD OF THE INVENTION

The present invention relates to an apparatus and system for evaluating the surface and sub-surface properties of a surface and, in particular, to an apparatus and system for irradiating the surface with adjustable polarized light and viewing the optical reflectance through a polarizing viewer.

### BACKGROUND OF THE INVENTION

Light reflected from skin has two components: regular reflectance, or “glare” arising from the surface, and light backscattered from within the tissue. The regular reflectance contains the visual cues related to surface texture, whereas the backscattered component contains the cues related to pigmentation, erythema, infiltrates, vessels and other intracutaneous structures. Unlike the backscattered component, regular reflectance preserves the plane of polarization of polarized incident light. Thus, viewing skin through a linear polarizer, under linearly polarized illumination, separates the two components of tissue reflectance. When the planes of polarization are parallel, images with enhanced surface detail are obtained. When the planes are orthogonal, wrinkles and surface detail disappear, and an enhanced view of vasculature, pigmented lesions, and other subsurface details is obtained.

The prior art discloses various devices and methods that accomplish surface irradiation and reflection detection. However, none of the prior art devices or methods provide a means or method of illuminating a surface and then view either surface or subsurface reflectance at the discretion of the user. The prior art also requires elaborate and often fixed setups to perform any type of surface analysis. These setups usually require the surface of interest to be moved past a positioned optical array. There is little teaching of portable units that would enable the imaging to be done in remote locations or manipulate the illuminator source with respect to the object being viewed. Finally, most prior art systems are costly and, therefore, are not practical for those with limited resources.

For example, U.S. Pat. No. 2,120,365, issued to Kriebel, discloses the use of polarizing lenses in eyeglasses for orthogonally polarizing light being viewed. The light originates from a source located on the side of an object or material of interest opposite to the viewer, which allows for examining the photo-elastic effects of the light bending around the object.

U.S. Pat. No. 2,947,212 to Woods shows detection of surface conditions of sheet metal by irradiating a surface with polarized light and using a polarizer in the optical path of the detector. This allows for only the viewing the intensity of the polarized light while eliminating all extraneous light rays. Similarly, U.S. Pat. No. 3,904,293 to Gee uses linearly polarized light to irradiate a surface and then detection of the reflected light. Prior to the reflected light being detected, it must first pass through a polarizing beam splitter, which separates the light into its principal polarized (incident) and orthogonally polarized (depolarized) wave components. These two distinct waves are then detected by different detectors, and changes in the surface texture will cause corresponding changes in the detected signal characteristics to be compared.

U.S. Pat. No. 5,053,704, issued to Fitzpatrick, discloses the imaging of a surface to detect cracks, flaws, voids, and the like. To accomplish this detection, a magneto-optical substrate including a conductive sheet is laid over the target material. A current is passed through the conductive sheet to provide a biased magnetic field. Polarized light is then directed through the substrate into the target material and the reflected light is viewed through a separate linear polarizer. The biased magnetic field induces a rotation of the plane of polarization of the incident projected light such that viewing the reflection through a linear polarizer will render flaws visible.

U.S. Pat. No. 5,198,875, issued to Bazin et al., also teaches irradiation of a surface with polarized light. Bazin et al sets up two detectors, one at an angle of reflectance equal to the angle of incident while another detector is located perpendicularly to the surface. The reflected polarized light is passed through polarization separation cubes and eventually four detectors detect the reflected light. These detectors are connected through an electronic processing means, which evaluates the various signals for brightness comparison.

U.S. Pat. No. 5,442,489 to Yamamoto et al relates to a magnifying apparatus. A polarized light irradiates an object and the reflected light is transmitted through a polarizing means and is in turn imaged by an imaging device. This arrangement magnifies and images practical areas of interest.

The article, “Polarized Light Examination and Photography of the Skin” by Rox Anderson, MD, which appeared in the Archives of Dermatology, July 1991, volume 127, pages 1000-1005, describes the above mentioned failings in the art to provide adequate viewing of surface and subsurface epidermis. In response to these failings, the authors of the article developed the polarized material inspection apparatus that is described in U.S. Pat. No. 5,742,392, which is incorporated herein by reference. This apparatus, although providing distinct advantages over prior art systems, has certain attributes that have been seen as drawbacks in some circumstances.

First, the use of a head-mounted apparatus, often connected by wires to a power supply, has been found to restrict the movement of physicians utilizing the apparatus. Second, the mounting of a hot lamp in close proximity to the user's head can cause the user to overheat and perspire. Third, head mounting of the unit creates the risk of a user temporarily blinding others within the operating room by inadvertently pointing the light source at the eyes of that person. Finally, the weight of the head-mounted apparatus can, during periods of extended wear, cause neck strain and general discomfort to the user.

In addition, as the Anderson apparatus includes the light source and first polarizer, others viewing the image at different positions around the object will see a different image when they utilize polarizers set to the same level of polarization as those of the apparatus worn by the user. This inability to coordinate the images viewed is due to the difference in the optical path of the polarized light caused by the different angular arrangement of the other viewers from the light source. Accordingly, the Anderson apparatus has not heretofore been adapted for use with remotely mounted cameras, which have utility in the growing field of telesurgerey, nor for teaching or collaborative procedures where it is important for all present to view the same image. Similarly, as there has heretofore been no way for a camera to view the same image as is seen by a user, there has also been no way to record and save what the user sees for future use during litigation, case review or for teaching purposes.

Therefore, there is a need for a device for irradiating a surface with polarized light in association with a polarized viewer that provides separation between surface and subsurface reflection, that allows the light source and viewer to be integrally or remotely connected, that allows either the surface or subsurface reflectance to be viewed alternatively and at the discretion of the user or a third party viewer, that does not restrict the movement of the user or cause the user to perspire, that eliminates the risk of a user temporarily blinding another person by inadvertently pointing the light source at the other person's eyes. Further, there is a need for a system for irradiating a surface with polarized light in association with a polarized viewer that provides separation between surface and subsurface reflection, that allows cameras and other viewers within a room to see the same image as is seen by the user of the device and allows the image viewed by the user to be stored for later viewing.

### SUMMARY OF THE INVENTION

The present invention is a polarized material inspection apparatus for viewing a material with a polarized light, and a polarized material inspection system utilizing the same.

In its most basic form, the polarized material inspection apparatus includes a light source having a first optical path, a first polarizing filter disposed within the first optical path of the light source, a frame, a second polarizing filter disposed within the frame, and a support attached to the frame for positioning the frame.

In the preferred polarized material inspection apparatus, the second polarizer is rotatably attached to the frame such that a rotational position of the second polarizer is adjustable to a desired level of polarization relative to the first polarizer. The preferred embodiment also includes an imaging means, such as a camera or charge coupled device, which is disposed proximate to the second polarizing filter such that the second polarizing filter and imaging means lie within a second optical path.

Some embodiments of the present invention include a polarization level selection means for selecting a desired level of polarization. In its simplest form, the polarization level selection means is a lever, mechanically coupled to either the first or second polarizing filter, which, when moved, rotates the polarizing filter. Those of ordinary skill in the art would also recognize that the polarization level selection means could alternatively be in the form of a knob, dial, or the like, mechanically coupled to polarizing filter which, when rotated, causes the polarizing filter to rotate relative to the other polarizing filter.

Other embodiments include a control means that allows the polarization level selection means to be physically displaced from the second polarizing filter. In this arrangement, the polarization level selection means generates an output, preferably in the form of a digital electrical signal, which in turn is received by the control means, which is preferably a servomotor that sets the rotational position of the second polarizing filter in response the signal received from the selection means. Although the preferred output from the selection means is a digital electrical signal, those of ordinary skill in the art would also recognize that this signal could alternatively be in the form of an analog electrical signal, a radio wave, a fiber optic signal, an infrared light signal, an acoustical signal, or a pneumatic signal. Similarly, although the preferred control means is a servomotor, those of ordinary skill in the art would also recognize that a solenoid, motor, synchronous motor, stepping motor, pneumatic cylinder, pneumatic bellows, or the like, could be substituted for the preferred servomotor to achieve similar results.

In still other embodiments, a position sensing means monitors the position of the light source relative to the second polarizing filter and communicates with the control means to adjust the position of the second polarizing filter. The preferred position sensing means includes a radio signal transceiver co-located with the light source, a radio wave transponder co-located with the second polarizing filter, and a microprocessor, which calculates the position of the second polarizing filter relative to the light source based on direction finding and range finding between the transceiver and the transponder. The transceiver transmits the above-calculated positional information to the control means, which in turn adjusts the level of polarization based upon the selected polarization level and the position of the light source relative to the second polarizing filter. The selected level of polarization is thereby continuously maintained as the position of the light source relative to the second polarizing filter is changed. Although the preferred position sensing means is based on a radio wave transceiver, transponder and microprocessor system, those of ordinary skill in the art would also recognize the position sensing could alternatively be based on a GPS (global positioning satellite) system, an optical transceiver-transponder system, an acoustical transceiver-transponder system, or any other art recognized means of transmitting orientation.

In some embodiments of the invention, a polarization level sensing means is added to the apparatus to determine the level of polarization of the second polarizer. This polarization level sensing means is useful in embodiments of the system that allow multiple users to see an image with the same level of polarization as a designated user, such as a physician performing a procedure, a physician viewing the procedure via a remote network connection, or the like.

In an alternative embodiment, the apparatus is constructed to function as an electronic mirror. In these embodiments, an imaging means, such as a camera or charge coupled device, is again disposed proximate to the second polarizing filter such that the second polarizing filter and imaging means lie within a second optical path. The imaging means then sends the image to a display screen. The display screen may take many forms, and may or may not be attached to the frame. Preferred embodiments of the electronic mirror include image storage means for storing a desired image and image manipulation means for manipulating the image.

Therefore, it is an aspect of the invention to provide a device and system for irradiating a surface with polarized light in association with a polarized viewer that provides separation between surface and subsurface reflection.

It is another aspect of the invention to provide a device and system for irradiating a surface in which the light source and viewer may be integrally or remotely connected.

It is another aspect of the invention to provide a device and system for irradiating a surface that allows either the surface or subsurface reflectance to be viewed alternatively and at the discretion of the user.

It is another aspect of the invention to provide a device and system for irradiating a surface that does not restrict the movement of the user.

It is another aspect of the invention to provide a device and system for irradiating a surface that does not cause the user to perspire.

It is another aspect of the invention to provide a device and system for irradiating a surface with polarized light and to provide an independent self supported device for viewing, through a second polarizing filter, a portion of this polarized light that is reflected off of the surface.

It is another aspect of the invention to provide a device and system for irradiating a surface that eliminates the risk of a user temporarily blinding another person by inadvertently pointing the light source at the other person's eyes.

It is another aspect of the invention to provide a device and system for capturing, transmitting and/or storing the same image that is viewed by a user.

It is another aspect of the invention to provide a device and system in which a user may face a display screen, be irradiated with polarized light, and view a reproduced image of his or her own face with a desired level of polarization, magnification, or the like.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

FIG. 1 is an isometric view of a basic embodiment of the apparatus of the present invention.

FIG. 2 is an isometric view of one embodiment of the apparatus of the present invention.

FIG. 3 is an isometric view of another embodiment of the device of the present invention.

FIG. 4 is an isometric view of a one embodiment of the system of the present invention.

FIG. 5 is an isometric view of the system of FIG. 4 utilizing an imaging means and a fixed light source.

FIG. 6 is an isometric view of a frame mounted polarizing filter having a polarization level selection means.

FIG. 7 is an isometric view of a frame mounted polarizing filter having a polarization level control means and a polarization level sensing means.

FIG. 8 is an isometric view of one embodiment of the system of the present invention that includes a display, and a transceiver for communicating with the apparatus a pair of head worn polarizing glasses, and a central processing unit.

FIG. 9 is an isometric view of the system of FIG. 5 utilizing a fixed imaging means.

FIG. 10 is an isometric view of an alternative embodiment of the present invention in which a light source, a camera, first and second polarizers, and a display screen are combined to function as an electronic mirror.

### DETAILED DESCRIPTION OF THE INVENTION

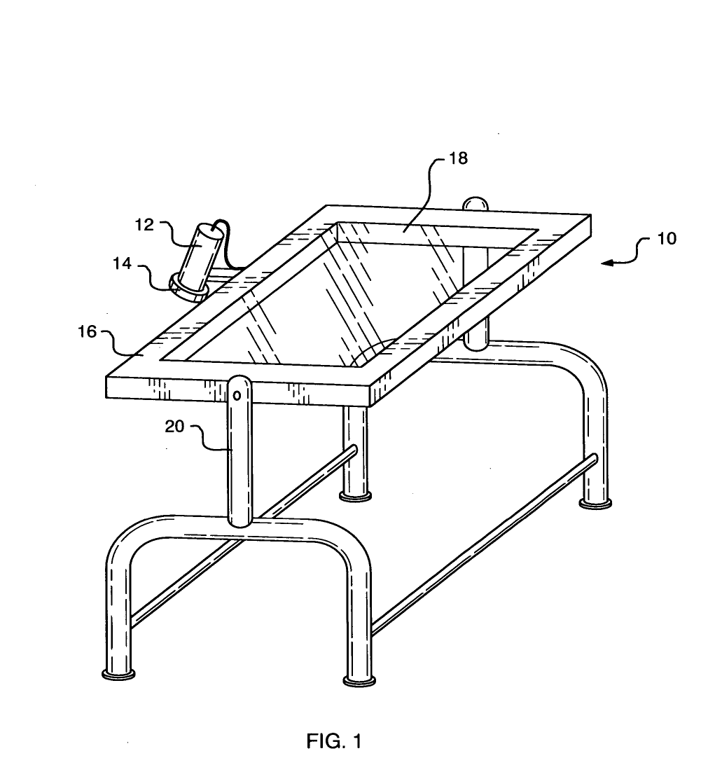

Referring first to FIG. 1, an isometric view of the basic embodiment of the device 10 is shown. The basic embodiment includes a light source 12, a first polarizing filter 14 disposed within the optical path of the light source, a frame 16 into which a second polarizing filter 18 is disposed, and a support 20 for positioning the frame 16 such that an object (not shown) may be viewed through the second polarizing filter 18. The first polarizing filter 14 and second polarizing filter 14 each have a plane of polarization, and the first polarizing filter 14 and/or the second polarizing filter 18 are rotatable through a ninety degree arc such that the planes of polarization may be adjusted to be parallel or orthogonal to one another.

As shown in FIG. 1, it is preferred that the light source 12 be attached to the frame 16 and positioned such that the light from the light source 12 is reflected back through the second polarizing filter 18. In this embodiment, the first polarizing filter 14 is mounted directly to the light source 12 and is rotatable through a ninety-degree arc. However, it is understood that other embodiments may include a first polarizing filter 14 mounted separately from the light source 12. FIG. 1 also shows the support 20 being a table to which the frame 16 is rotatably mounted. It is noted, however, that this support 20 may be varied in other embodiments to provide proper positioning for different objects to be viewed.

In operation, the device 10 will be positioned relative to an object to be viewed, the light source 12 will be energized and the light will be polarized by the first polarizing filter 14 and will pass on to illuminate the object. The light will then be reflected off of the object and will pass through the second polarizing filter 18 for viewing by the user. Depending upon the details to be viewed, the first polarizing filter 14 may be rotated into a parallel relationship to the second polarizing filter 18, or may be rotated into an orthogonal relationship to the second polarizing filter 18.

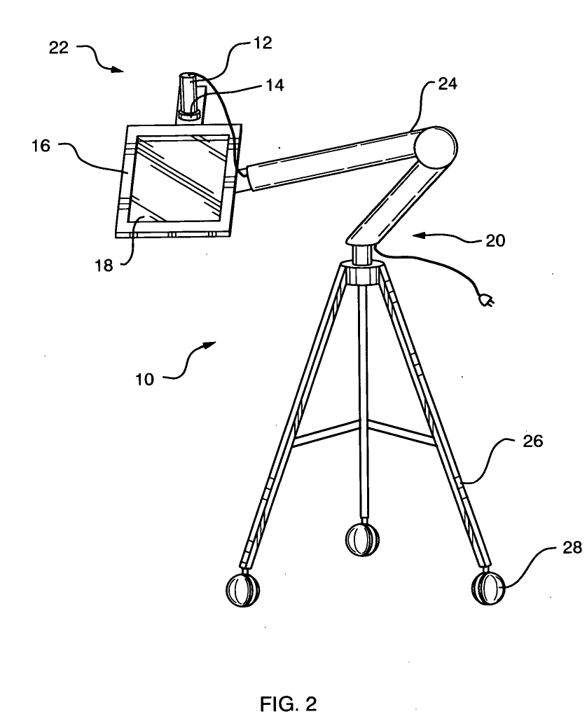

Referring now to FIG. 2, the preferred embodiment of the device 10 of the present invention is shown. In this embodiment, the light source 12 and first polarizing filter 14 are included in a single Seymour light illumination assembly 22. The preferred frame 16 is mounted to a support 20 that includes an adjustable arm 24 and a tripod 26 to which the adjustable arm 24 is attached. The adjustable arm 24 and tripod 26 of the preferred support 20 allow the user to manipulate the frame 16 to a wide range of positions in order to illuminate the desired surface and to allow the user to view the surface through the second polarizing filter 18. As also shown in FIG. 2, the support 20 may include a plurality of casters 28, or other movement aids such as wheels, glides, or the like, to allow the device 10 to be easily moved and positioned relative to the surface to be viewed.

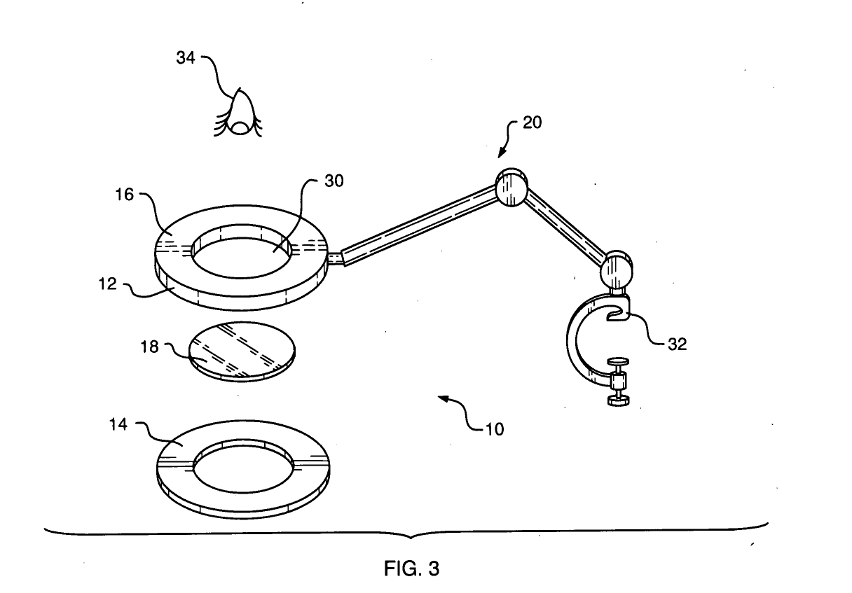

Referring now to FIG. 3, an exploded isometric view of an alternative embodiment of the device 10 is shown. In this embodiment, a common desktop magnifier may be modified to produce a device 10 in accordance with the present invention.

As shown in FIG. 3, an adjustable arm 24 is provided with an attachment for attaching the device 10 to a desk or other surface. The adjustable arm 24 is rotatably attached to the frame 16, allowing the device to be manipulated to a wide range of positions. The frame 16 is preferably substantially cylindrical and includes a central opening into which a magnifying lens 30 is mounted. A light source 12 is attached between the underside of the frame 16 between and a first polarizing filter 14. The first polarizing filter 14 is dimensioned to mate with, and rotatably attach to the underside of the frame 16. The second polarizing filter 18 is dimensioned to mate with the magnifying lens 30 and is secured in a mating relationship with the lens 30. In the embodiment of FIG. 3, the second polarizing filter 18 is preferably a flexible polarizing film that is adhered directly to the undersurface of the lens 30. In other embodiments, however, the second polarizing filter 18 may be a glass filter secured to the underside of the frame 16 via mechanical means.

In operation, a user will position the device 10 in the desired position relative to the surface to be viewed and position their eye 34 above the magnifying lens 30 to view the surface. The first polarizing filter 14 may then be rotated such that the planes of polarization of the first polarizing filter 14 and the second polarizing filter 18 are in parallel relation to one another and to be rotated again such that the planes of polarization are in orthogonal relation.

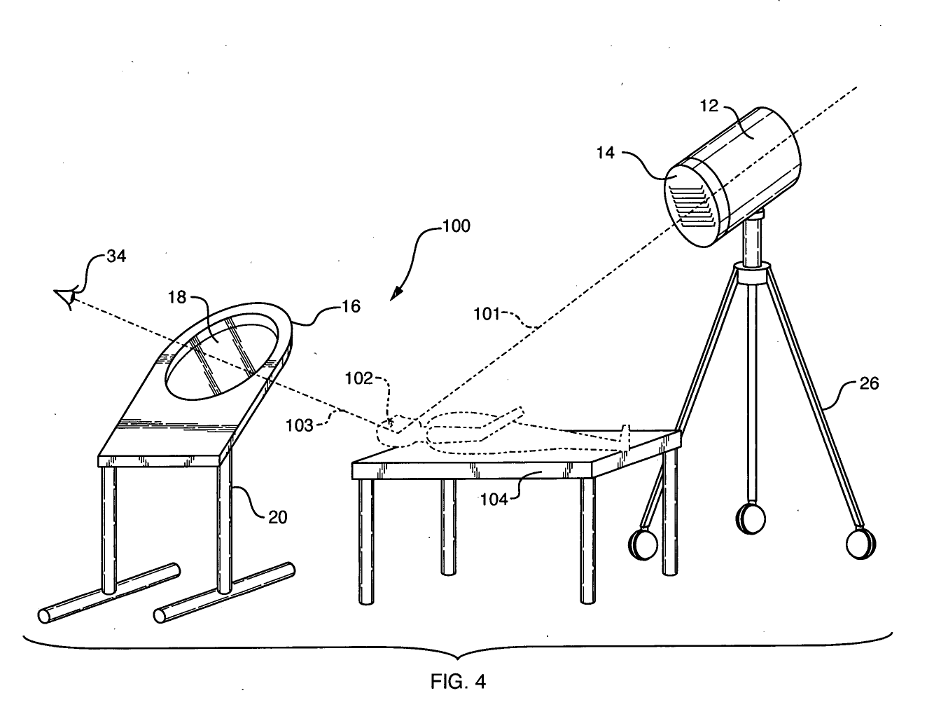

Referring now to FIG. 4, an embodiment of the system is shown in which the light source 12 and first polarizing filter 14 are adjustably mounted to a tripod 26, which is separate from frame 16. In this embodiment, the mobility of the tripod 26, and the adjustability of the light source 12 and first polarizing filter 14 with respect to tripod 26, allows the emitted light to be directed as desired by the user. However, as explained in detail below with respect to other embodiments, the light source 12 and polarizing filter 14 may also be adjustably or fixedly mounted to a stationary or movable support or other object to achieve similar results.

In FIG. 4 the light source is directed to illuminate a patient 102 on table 104. In this embodiment, the first polarizing filter 14 is attached to light source 12 in a fixed relationship, the second polarizing filter 18 is adjustably mounted to frame 16, and the frame 16 is attached to the support 20. In operation, the light source 12 emits light that passes through the first polarizing filter and forms a first optical path 101 with the object to be viewed, and the support 20 is positioned such that second polarizing filter 18 lies within a second optical path 103 defined by a line between the eye 34 of the user and the object being viewed; the patient 102 in this example. The rotational position of second polarizing filter 18 is then adjusted to achieve the desired level of polarization.

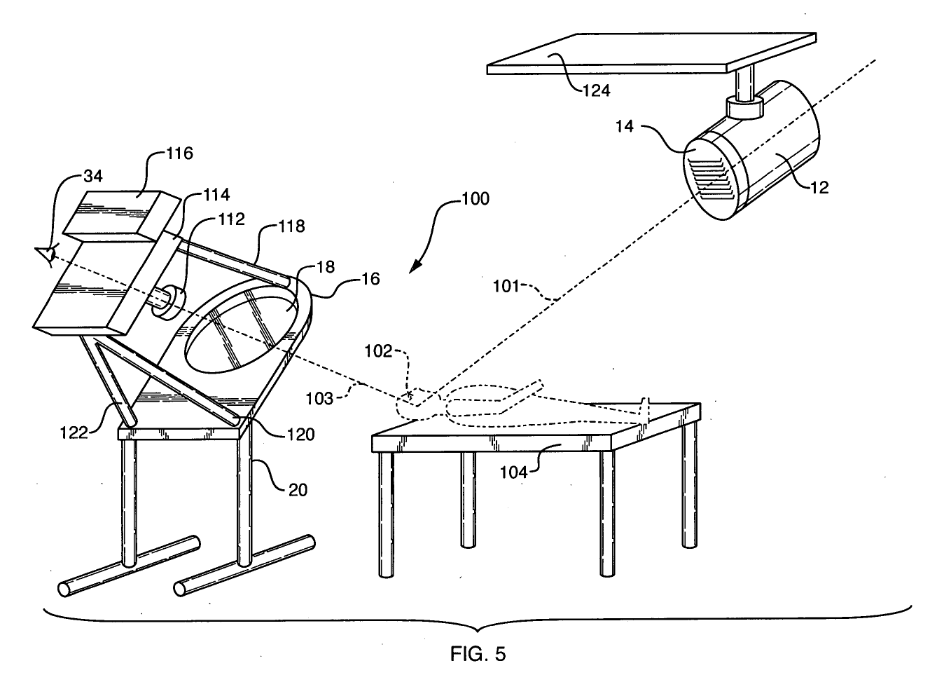

Referring now to FIG. 5, another embodiment of the system is shown. In this embodiment, an imaging means 112, an image storage means 114, and an image transmission means 116 are attached to frame 16, preferably via stanchions 118, 120 and 122, or via brackets, frames, or the like, such that the imaging means 112 and image storage means 114 lie within the second optical path 103 created by the reflection of light emanating from the light source 12 and through the first polarizing filter 14. In the embodiment of in FIG. 5, the light source 12 and first polarizing filter 14 are attached to a fixed structure 124, such as a ceiling of a room, and is directed upon the object to be viewed such that first optical path 101 is formed therebetween. However, as noted above, the light source 12 could be mounted in many arrangements to achieve similar results.

Although FIG. 5 shows the combination of an imaging means 112, an image storage means 114, and an image transmission means 116, it is recognized that an imaging means alone could be used. In such embodiments, the imaging means may take the form of a simple lens for direct viewing of the image through the eye 34 of the user. In other embodiments, the lens may include specialized filters and or magnifying attachments to allow the user to alter a desired view.

In other embodiments, the imaging means 112 is used in concert with the image storage means 114 without any image transmission means 116. In such embodiments, the combination of the imaging means 112 and the image storage means 114 may be an image storing camera, such as a film based camera, a photographic plate based camera, a video tape based camera or an electronic camera which stores images directly on storage media such as a memory chip, memory card, CD ROM, magnetic disc or tape, or other art recognized storage media. Such embodiments are useful as a means for documenting a procedure for later retrieval during subsequent visits, litigation, or for other art recognized purposes.

In still other embodiments, the image storage means 114 is eliminated. In such embodiments, the image transmission means 116 receives the output of the imaging means 112 and transmits the image to a remote location, either by cable or by a “wireless” system, such as transmission of radio waves, television broadcast or infrared (IR) transmission. In this context, the imaging means 112 is a camera of either a charge coupled device (CCD) or television type camera, which allows the image to be viewed in “real time” at a remote location. As noted above, such a system is useful in the growing field of telesurgery, which allows experienced surgeons in remote locations to provide their expertise to performing physicians in real time during the course of a medical procedure.

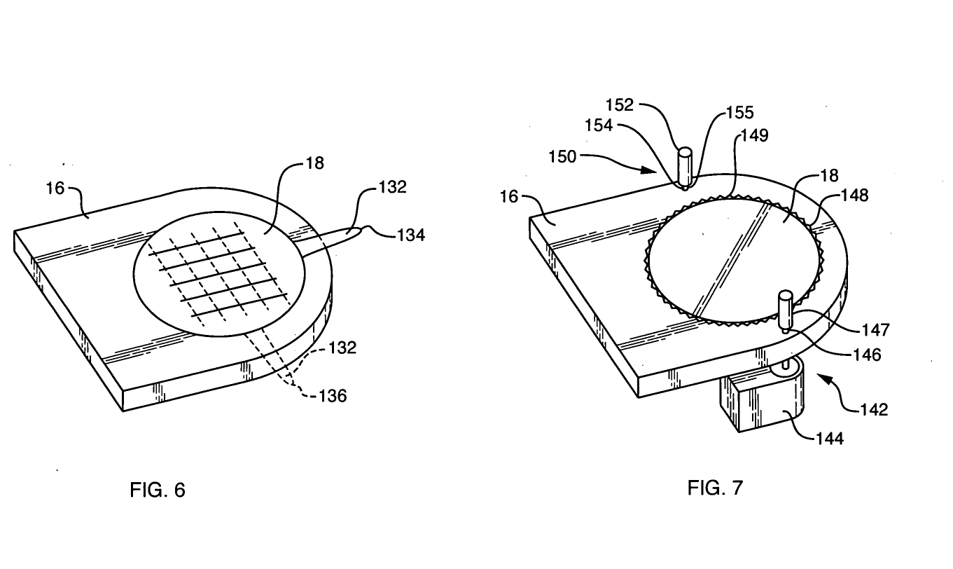

Referring now to FIG. 6, one embodiment of a polarization level selection means 132 is shown in a first position 134, with dotted lines utilized to indicate movement of the selection means 132 to a second position 136. The embodiment of the polarization selection means 132 shown in FIG. 6 is a simple lever directly attached to the second polarizing filter 18 such that when the lever is rotated the second polarization filter 18 rotates through the same angular displacement. However, although a lever has been disclosed, those of ordinary skill in the art would understand that the polarization level selection means could also take the form of a knob, dial, or the like. Similarly, the selector may be mechanically coupled to a pair of second polarizing filters (not shown) which, when rotated, causes the second polarizing filters to rotate.

Referring now to FIG. 7, a control means 144 may be used to allow the polarization level selection means (not shown) to be physically displaced from the second polarizing filter 18. The preferred control means 14 includes a servomotor 144 and an output pinion gear 146 having output pinion gear teeth 147. A ring gear 148 with ring gear teeth 149 on its outside diameter is fixedly attached to the perimeter of the second polarizing filter 18. The servomotor 144 is attached to frame 16 such that the axis of rotation of the output pinion gear 148 is parallel to the axis of rotation of the second polarizing filter 18 and output pinion gear teeth 147 mesh with ring gear teeth 149. In operation, the servomotor 144 receives a signal from the polarization level selection means (not shown), which causes the output pinion gear 146 to rotate through a specific angular displacement proportional to the degree of polarization selected by the user. The rotation of the output pinion gear 146 causes the second polarizing filter 18 to rotate via the meshing of output pinion gear teeth 147 and ring gear teeth 149. In such an embodiment, the polarization level selection means may be a knob, keyboard, switch, voice activated control, or other means for a user to select a desired level of polarization from a location remote from the second polarizing filter 18.

FIG. 7 also shows a polarization level sensing means 150 for sensing a level of polarization of the second polarizer 18. The preferred polarization level sensing means 150 includes a rotational position encoder 152 having and input pinion gear 154 with input pinion gear teeth 155. The rotational position encoder 152 is attached to frame 16 such that the axis of rotation of the input pinion gear 154 is parallel to the axis of rotation of the second polarizing filter 18 and input pinion gear teeth 155 mesh with ring gear teeth 149. In operation the rotation of the second polarizing filter 18 causes the rotational position encoder 152 to rotate via the meshing of input pinion gear teeth 155 and ring gear teeth 149. This resultant rotation of the rotational position encoder 152 generates a signal proportional to the angular displacement of the second polarizing filter 18. As noted with reference to the embodiments of the system described below, knowing the angular displacement of the filter is important in coordinating polarization levels among users to insuring that all users of the system are able to view the same image.

Although a control system using a servomotor and a ring and pinion gear system has be disclosed, those of ordinary skill in the art would also recognize that other components, such as chains and sprockets, belts and pulleys, linear actuators coupled with flexible cables, friction drive, or the like could be substituted for the preferred servomotor and a ring and pinion gear components to achieve similar results. It is also recognized that there need not be mechanical contact between the control means actuator, e.g., the servomotor, and the second polarizing filter 18, and that a non-contact control means, such as a system using magnetic coupling to rotate the second polarizing filter, may be utilized to achieve similar results. Similarly, one of ordinary skill in the art would also recognize that other position sensing means, such as optical encoding, hall effect sensing, rotary potentiometers, or the like, could be substituted for the disclosed means in order to achieve similar results.

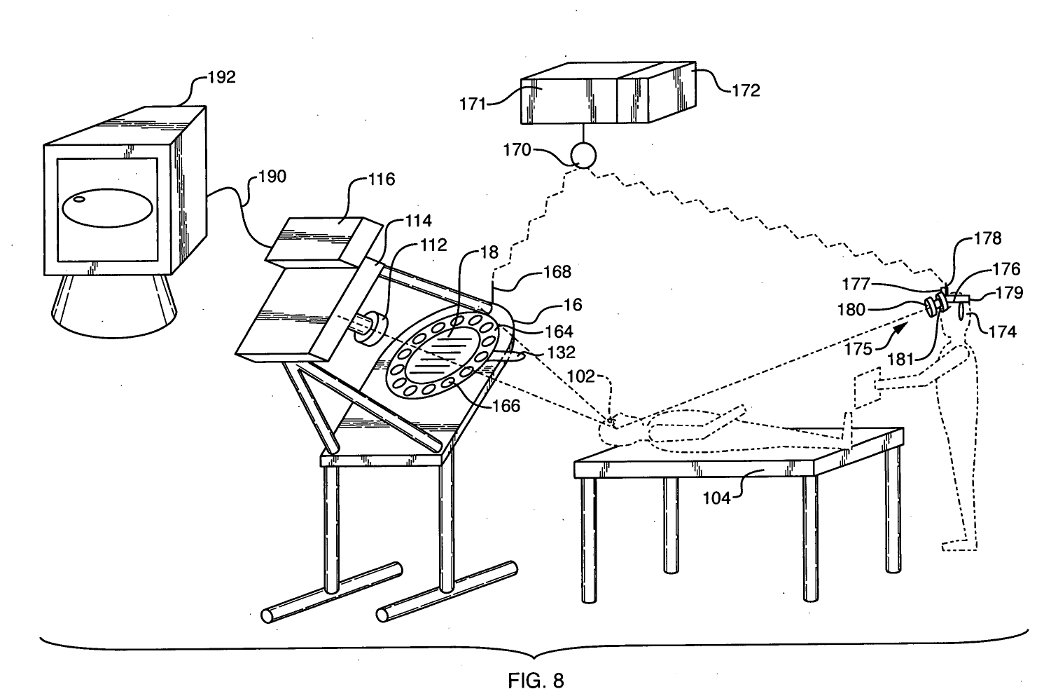

Referring now to FIG. 8, still another embodiment of the system of the present invention is shown. In this embodiment, an annular light source 166 is attached to frame 16 such that the light emitted passes through an annular polarizing filter 164 and illuminates patient 102. The annular light source 166 shown in the FIG. 8 is in the form of a plurality of light bulbs arranged in a circular pattern, where the center of the circular pattern is co-located with the center of the first annular polarizing filter 164. However, one of ordinary skill in the art would recognize that that the annular light source 166 could be of other forms, such as a single light bulb of annular shape, a plurality of light emitting diodes arranged in an annular shape, a plurality of fiber-optic cables whose output ends are arranged in an annular shape, or the like. Further, it is obvious from the other drawing figures and descriptions herein that the light source may take many physical forms and need not be annular.

In the embodiment of FIG. 8, the second polarizing filter 18 is disposed in the central region of annular polarizing filter 164 and rotatably attached to the annular polarizing filter 164 such that the degree of cross polarization between the annular polarizing filter 164 and the second polarizing filter 18 can be set to any desired level of polarization ranging between orthogonal and parallel relative to the polarizing filter 164. This may be accomplished manipulating a polarization level selection means 132, such as those described with reference to FIG. 6.

In operation some of the light emitted by the annular light source 166 is reflected off of the patient 102 and returns trough the second polarizing filter 18. In this embodiment, a polarization level sensing means (not shown), such as those described with reference to FIG. 7, emits an output via a first antenna 168. The antenna 168 may be fixedly attached to frame 16, as shown in FIG. 8, or may be mounted remotely from the frame 16 and connected to the polarization level sensing means via a suitable cable.

An imaging means 112 for viewing an image, an image storage means 114 for storing the image viewed by the imaging means 112, and an image transmission means 116 for transmitting the stored image are attached fixedly to frame 16 in the manner described in FIG. 5. The output of the image transmission means 116 is conveyed to display screen 192 via cable 190. Although FIG. 8 shows a display screen in the form of a typical CRT based computer monitor one of ordinary skill in the art would recognize that a “flat panel” display, television screen, projector and screen system or the like could be substituted to achieve the same result. Similarly, although cable 190 is shown, one of ordinary skill in the art would recognize that a “wireless” system could be used to convey the output of image transmission means 116 to display screen 192.

The user 174 is shown wearing polarizing glasses 175 having a glass frame 176, a first transceiver 177, a first antenna 178, a spatial position sensor 179 and polarizing lenses 180 and 181. The first transceiver 177 transmits and receives through a second antenna 178. Polarizing lenses 180 and 181 are rotatably attached to the glass frame 176. The angular position of polarizing lens 180 is set by a control means (not shown), which functions in the same manner as the control means described with reference to FIG. 7. In this embodiment, a servomotor (not shown) is mounted to glass frame 176, the servomotor rotates polarizing lens 180, a synchronizing system (not shown) is used to rotate polarizing lens 181 through the same angular displacement as polarizing lens 180. The preferred synchronizing system is a toothed belt-sprocket system, other synchronizing systems, such as meshing spur gears, meshing rack and pinion gears, synchronous motors, or the like, would be recognized as suitable substitutes by one of ordinary skill in the art. A central processing unit 172 connected to second transceiver 171 is shown in FIG. 8. The second transceiver 171 transmits and receives through third antenna 170.

In operation the user 174 sets the desired level of polarization via polarization level selection means 132. The output signal of the polarization level sensing means 150 is emitted via a first antenna 168 and received by second transceiver 171 via third antenna 170. The first transceiver 177 transmits positional information from spatial position sensor 179 via antenna 178 to second transceiver 171 via third antenna 170. The central processing unit 172 then (based on spatial positional information from the spatial position sensor 179 and polarization level from polarization level sensing means 150) calculates the angular position of polarizing lenses 180 and 181 required to provide user 174 with the same level of polarization as exists between annular polarizing filter 164 and second polarizing filter 18. The calculated angular position is then transmitted via the second transceiver 171 and third antenna 170 to the first transceiver 177 via first antenna 178. The first transceiver 177 then provides this calculated angular position to a control means (not shown) which functions in the same manner as the control means described in FIG. 7. This control means then rotates the polarizing lenses 180 and 181 to the calculated position. This communication of positional information and polarization level is continuously communicated to the central processing unit 172 such that the required angular position of polarizing lenses 180 and 181 is continuously recalculated. This allows for the desired polarization level between polarizing lenses 180 and 181 and annular polarizing filter 164 to be maintained as either the position of the user 174 changes, the desired polarization level is changed (via the polarization level selection means 132), or both.

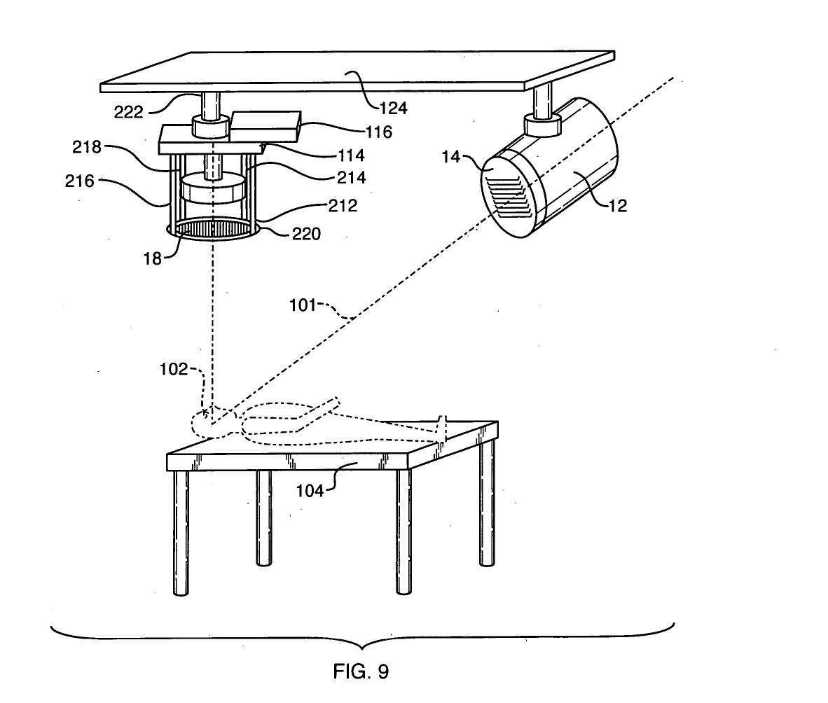

Referring now to FIG. 9, another embodiment of the system is shown. In this embodiment, an imaging means 112, an image storage means 114, and an image transmission means 116 are attached fixedly to frame 220, preferably via stanchions 212, 214, 216 and 218 such that the imaging means 112 and image storage means 114 lie within the second optical path created by the reflection of light off of patient 102 emanating from the light source 12 and passing through the first polarizing filter 14. As shown in FIG. 9, the combination the imaging means 112, image storage means 114, image transmission means 116, stanchions 212, 214, 216 and 218, second polarizing filter 18 and frame 220, are attached to a fixed structure 124, such as a ceiling of a room via support 222. Support 222 is adjustable such that the imaging means 112, image storage means 114, image transmission means 116 and attached second polarizing filter 18 can be aimed as desired with respect to patient 102. Although no specific structures for the adjustment of support 222 are shown in the figure or herein recited, the use of well known mechanisms such as ball and socket joints, universal joints, gimbaled joints, swivel joints and the like would be obvious to one skilled in the art.

In operation the user (not shown) positions patient 102 (on table 104) in the desired position, relative to the imaging means 112 and light source 12. The user then adjusts support 222 as required to aim imaging means 112 at precise region on the patient for which viewing is desired. The user then selects the desired level of polarization via a polarization level selection means (not shown). Although a polarization level selection means is not shown, it is understood that it could be a device such as polarization level selection means 132 as described with respect to FIG. 6. The user then energizes light source 12. Light emitted from light source 12 passes through first polarizing filter 14 and illuminates the desired region of patient 102. A portion of this polarized light from light source 12 is reflected off of patient 102 and passes through second polarizing filter 18 before reaching imaging means 112. The user can, at his or her discretion, store the image via image storage means 114 or transmit the image via image transmission means 116, or do both if desired.

Although the combination the imaging means 112, image storage means 114, image transmission means 116, stanchions 212, 214, 216 and 218, second polarizing filter 18 and frame 220, are shown and describes as attached, via support 222, to a fixed structure 124, such as a ceiling of a room, it would be understood by one skilled in the art that other fixed structures such as the wall or floor or a room could be substituted.

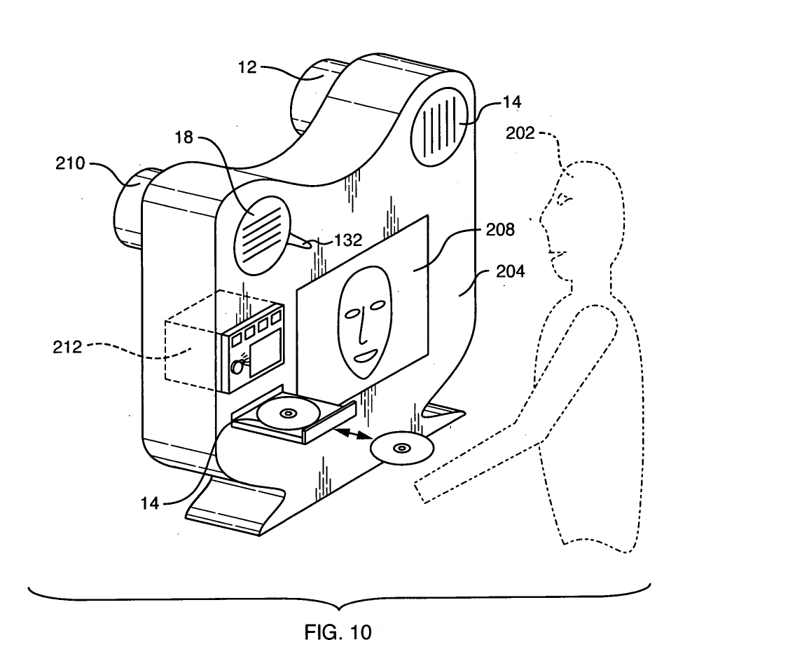

Referring now to FIG. 10, light source 12, camera 210, display screen 208, image manipulation means 212 and image storage means 214 are attached to frame 204. First polarizing filter 14 is attached to light source 12 such that light emitted from light source 12 first passes through first polarizing filter 14 before illuminating viewer 202. Second polarizing filter 18 is attached to camera 210 such that a portion of the light emitted from light source 12, which is reflected off of viewer 202, passes through second polarizing filter 18 before reaching camera 210. Second polarizing filter 18 is equipped with a polarization level selection mean 132 which functions as described in FIG. 6. Camera 210 is connected to image manipulation means 212 and image storage means 214 such that the image captured by camera 210 is provided to these components for manipulation and storage (if desired). The output of image manipulation means 212 is displayed on display screen 208. In operation the viewer 202 faces the display screen 208. While viewing the image displayed on display screen 208 the viewer selects the desired level of polarization via polarization level selection means 132. After attaining the desired level of polarization the viewer 202 can, if desired, manipulate the displayed image via the image manipulation means 212. The image manipulation means can be used to alter the brightness, contrast, hue and color balance of the displayed image. In the preferred embodiments, the image manipulation means is commercially available digital signal processing or digital image processing software. However, other non-digital methods and components for such image manipulation are well known to those of ordinary skill in the art, as is evidenced by the presence of these image manipulation features on commonly available computer monitors, television sets, etc. Accordingly, the image manipulation means should not be limited to digital means.

The viewer can, if desired, store the resulting displayed image via the image storage means 214. The preferred image storage means is a compact disk writer and compact disk, one of ordinary skill in the art would however recognize that other storage devices and media could be substituted such as a floppy disk drive and floppy disk, magnetic tape drive and magnetic tape, printer and paper, “RAM”, and the like.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

1. An inspection apparatus for viewing an object with a polarized light, said apparatus comprising:
a light source forming a first optical path with said object,
a first polarizing filter disposed within the first optical path;
a frame;
a second polarizing filter disposed within said frame; and
a support attached to said frame for positioning said frame.

2. The inspection apparatus of claim 1 wherein one of said first polarizing filter and said second polarizing filter is rotatable such that a rotational position of one of said first polarizing filter is adjustable to a desired level of polarization relative to another of said first polarizing filter and said second polarizing filter.

3. The inspection apparatus of claim 2 further comprising an imaging means forming a second optical path with said object, wherein said imaging means is disposed proximate said second polarizing filter such that said second polarizing filter lies within said second optical path.

4. The inspection apparatus of claim 3 wherein said imaging means comprises a camera.

5. The inspection apparatus of claim 4 wherein said camera comprises a charge coupled device.

6. The inspection apparatus of claim 3 further comprising a polarization level selection means for selecting a level of polarization.

7. The inspection apparatus of claim 6 further comprising a control means for controlling said level of polarization based upon an input from said polarization level selection means.

8. The inspection apparatus of claim 7 further comprising;
a position sensing means for identifying a position of said imaging means relative to said light source, said position sensing means being adapted to provide an input to said control means corresponding to said position;
wherein said control means comprises adjustment means for adjusting said level of polarization of said second polarizing filter based upon said inputs from said polarization level selection means and from said position sensing means.

9. The inspection apparatus of claim 8 further comprising a polarization level sensing means.

10. The inspection apparatus of claim 4 further comprising a display screen wherein said display screen displays an image captured said camera.

11. The inspection apparatus of claim 10 wherein said display screen is attached to said frame.

12. The inspection apparatus of claim 11 further comprising an image storage means.

13. The inspection apparatus of claim 11 further comprising an image manipulation means for manipulating said image captured by said camera.

14. The inspection apparatus of claim 13 further comprising an image storage means.

15. An inspection system for inspecting an object, said system comprising:
a light source forming a first optical path with said object;
a first polarizing filter disposed within the first optical path;
a first support attached to said light source and said first polarizing filter for positioning said light source and said first polarizing filter;
a frame,
a second polarizing filter disposed within said frame; and
a second support attached to said frame for positioning said frame.

16. The inspection system as claimed in claim 15 wherein one of said first polarizing filter and said second polarizing filter is rotatable such that a rotational position of one of said first polarizing filter is adjustable to a desired level of polarization relative to another of said first polarizing filter and said second polarizing filter

17. The inspection system of claim 16 further comprising an imaging means forming a second optical path with said object, wherein said imaging means is disposed proximate said second polarizing filter such that said second polarizing filter lies within said second optical path.

18. The inspection system of claim 17 wherein said imaging means comprises a camera.

19. The inspection system of claim 18 further comprising a display screen wherein said display screen displays an image captured said camera.

20. The inspection system of claim 19 wherein said display screen is attached to said frame.

21. The inspection apparatus of claim 18 further comprising an image storage means for storing an image captured by said camera.

22. The inspection system of claim 17 further comprising a polarization level selection means for selecting a level of polarization of said second polarizing filter.

23. The inspection system of claim 22 further comprising a control means for controlling said level of polarization of said second polarizing filter based upon an input from said polarization level selection means.

24. The inspection system of claim 23 further comprising;
a position sensing means for identifying a position of said imaging means relative to said light source, said position sensing means being adapted to provide an input to said control means corresponding to said position;
wherein said control means comprises adjustment means for adjusting said level of polarization of said second polarizing filter based upon said inputs from said polarization level selection means and from said position sensing means.

25. The inspection system of claim 24 further comprising a polarization level sensing means for sensing a level of polarization of said second polarizing filter.

26. The inspection system of claim 25 further comprising a polarized material inspection apparatus, said apparatus being adapted for wearing on a head of a user and comprising a third polarizing filter, a first transceiver and a first antenna.

27. An inspection system for inspecting an object, said system comprising:
a first inspection apparatus comprising:
a light source forming a first optical path with said object;
a first polarizing filter disposed within the first optical path;
a first frame,
a second polarizing filter disposed within said frame;
an imaging means forming a second optical path with said object, wherein said imaging means is disposed proximate said second polarizing filter such that said second polarizing filter lies within said second optical path; and
a support attached to said frame for positioning said frame; and
a second inspection apparatus comprising:
a second frame; and
a third polarizing filter attached to said second frame, said third polarizing filter forming a third optical path.

28. The inspection system as claimed in claim 27 wherein said second polarizing filter is rotatably attached to said first frame such that a rotational position of said second polarizing filter is adjustable to a desired level of polarization relative to said first polarizing filter, and said third polarizing filter is rotatably attached to said first frame such that a rotational position of said third polarizing filter is adjustable to a desired level of polarization relative to said first polarizing filter.

29. The inspection system of claim 27 wherein said imaging means comprises a camera.

30. The inspection system of claim 29 further comprising a display screen wherein said display screen displays an image captured said camera.

31. The inspection apparatus of claim 29 further comprising an image storage means for storing an image captured by said camera.

32. The inspection system of claim 27 further comprising a first polarization level selection means for selecting a level of polarization of said second polarizing filter and a second polarization level selection means for selecting a level of polarization of said third polarizing filter.

33. The inspection system of claim 32 further comprising a control means for controlling said level of polarization of said second polarizing filter based upon an input from said first polarization level selection means.

34. The inspection system of claim 33 wherein said control means further comprises means for controlling said level of polarization of said third polarizing filter based upon an input from said second polarization level selection means.

35. The inspection system of claim 34 further comprising a position sensing means for identifying a position of said imaging means and said third polarizing filter relative to said light source, said position sensing means being adapted to provide an input to said control means corresponding to said position;
wherein said control means comprises adjustment means for adjusting said level of polarization of said second polarizing filter and said third polarizing filter based upon said inputs from said first polarization level selection means and second polarization level selection means and from said first position sensing means and said second position sensing means.

36. The inspection system of claim 24 further comprising a first polarization level sensing means for sensing a level of polarization of said second polarizing filter and a second polarization level sensing means for sensing a level of polarization of said third polarizing filter.
